(19) United States
(12) Patent Application Publication
(10) Pub. No.: US 2016/0122006 A1
(43) Pub. Date: May 5, 2016

(54) LOW DRAG TURBULENCE GENERATORS FOR AIRCRAFT WINGS

(71) Applicant: Jack R. TAYLOR, Maineville, OH (US)

(72) Inventor: Jack R. TAYLOR, Maineville, OH (US)

(21) Appl. No.: 14/206,015

(22) Filed: Mar. 12, 2014

(51) Int. Cl. B64C 21/10; B64C 23/06; B64C 3/14

(52) U.S. Cl. CPC B64C 21/10; B64C 3/14; B64C 23/06; B64C 2003/146; B64C 2003/148; B64C 2230/26

(57) ABSTRACT

A wing design for an aircraft, including a plurality of turbulence generating devices distributed along a leading edge of a wing, configured in shape and in orientation to the wing to minimize drag and turbulence during cruising flight, and to increase turbulence during takeoff and landing.

### CROSS-REFERENCE TO RELATED APPLICATIONS

This application claims the benefit of U.S. Provisional application 61/798,818, filed Mar. 15, 2013, the disclosure of which is incorporated by reference in its entirety.

### FIELD OF THE INVENTION

The present invention is in the field of aerodynamic structures.

### BACKGROUND OF THE INVENTION

It is very important for all aircraft, commercial, military, and private, that they are able to take-off and land at low speeds and in a very short distance. Many different commercial aircraft have small turbulence generators placed on top of their wings, placed near the maximum thickness point of the wing section. The turbulence generators are usually small wing shaped objects that are placed in a row along a section of the wingspan. These small winglets are placed in alternating angles at high angles of attack, to generate tip vortices which creates turbulence near the wing to prevent the flow on the aft surface of the aircraft wing from separating at high angles of attack. This configuration permits the aircraft to takeoff and land at lower speeds. However, at cruising speed, the vortex generators cause increased drag and higher fuel consumption.

U.S. Pat. No. 6,431,498, the disclosure of which is incorporated by reference in its entirety, describes an apparatus having smoothly varying protrusions along the leading edge of a wing for increasing the lift over drag ratios.

### SUMMARY OF THE INVENTION

The present invention provides a wing design including a plurality of turbulence generating devices distributed along the leading edge of the wing. The turbulence generator is configured in shape and in orientation to the wing to minimize drag and turbulence during cruising flight, and to increase turbulence during takeoff and landing.

In an aspect of the invention, the turbulence generating device is fixed in orientation along the leading edge of the wing.

In another aspect of the invention, the turbulence generating device extends from the leading edge from a position just below the nose of the wing, at a point that defines the stagnation streamline at cruising conditions for the aircraft.

In another aspect of the invention, the turbulence generating device is planar, with its plane angled downward relative to the center chord line of the wing profile, and into the airflow stream approaching the leading edge of the wing with minimal or negligible angle of attack and minimal turbulence generated.

In another aspect of the invention, the shape of the turbulence generating device is angular, including triangular, with a corner of the triangular shape extended.

### BRIEF DESCRIPTION OF THE FIGURES

FIG. 1 shows a plan view of a typical aircraft wing with the turbulence generators on the leading edge of the wing.

FIG. 2 shows generators with an elliptical shape that could be used for this purpose.

FIG. 3 shows a typical wing section with the incidence angle set for cruise flight conditions. For this condition, the wing is set at a small incidence angle to generate enough lift to maintain the required altitude. The stagnation streamline approaches the leading edge of the wing with a small upward angle and impacts the wing just below the leading edge. Streamlines above the wing corner close to the upper surface of the wing which causes a reduction of pressure forces on the upper surface which generates a lifting force on the wing. Streamlines below the wing are deflected away from the wing which generates a higher pressure on the bottom surface of the wing which adds to the lifting force on the wing.

FIG. 4 shows the same airfoil at a much higher angle of attack (about 20 degrees), which would occur at a low airspeed with a stalled condition with high drag forces and a large area of very turbulent flow above the upper surface of the wing. FIG. 5 shows the same airfoil with turbulence generators at the leading edge of the wing, pointed in the direction of the approaching stagnation streamline. For cruise flight conditions, these turbulence generators would not cause any additional drag forces on the wing.

FIG. 6 shows the same airfoil, with the turbulence generators at a high angle of attack, the same as illustrated in FIG. 4. However, with the stagnation point below the leading edge of the wing, the turbulence generators are also at a high angle of attack with turbulent vortices generated on the sides of the generators. The turbulent eddies flow over the upper surface of the wings and prevent the flow separation that occurs in FIG. 4. This results in a much lower drag force and permits the airplane to land and takeoff at lower speeds without stalling the wings.

### DETAILED DESCRIPTION OF THE INVENTION

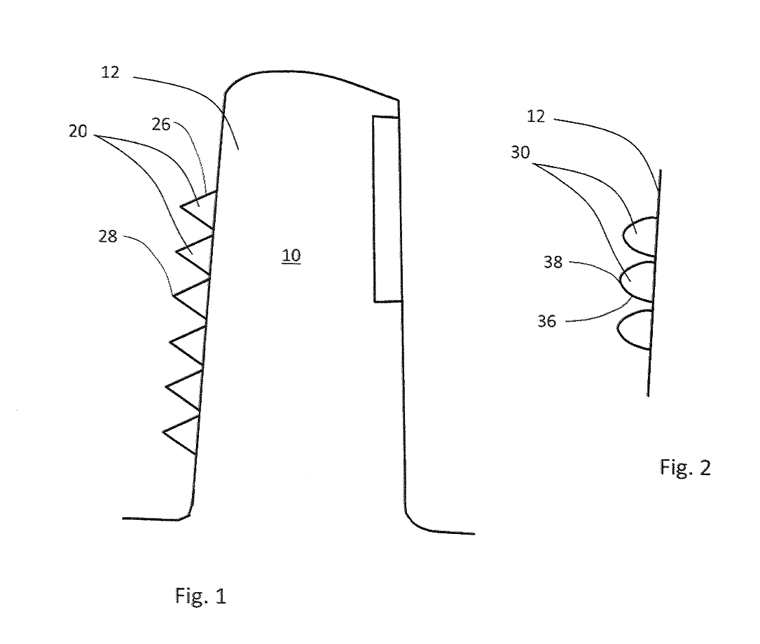

FIG. 1 shows a plan view of a typical aircraft wing 10 with the turbulence generators 20 on the leading edge 12 of the wing. The plurality of turbulence generators 20 typically number several, including the dozens, and many dozens, depending upon the design and size of the aircraft. The turbulence generators 20 can be spaced apart from one another, individually or in groups, as illustrated, or can be in contact with one another. The extending edge profile 26 of the turbulence generators 20 is angular or V-shaped, converging at a distal point 28.

FIG. 2 shows turbulence generators 30 with an elliptical shape along the leading edge 12 of the wing, including an extending edge 36 and a distal point 38.

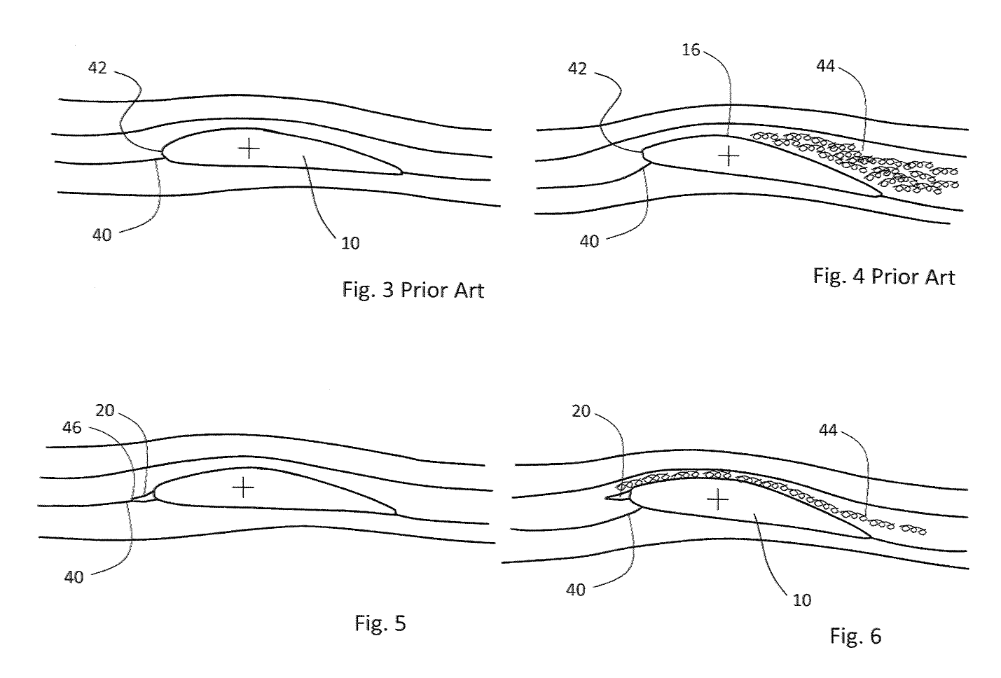

FIG. 3 shows the aircraft wing at cruise conditions for the aircraft. At cruise conditions, the center chord line of the wing profile is sloped upward at a small angle of attack, to generate the lift force L for the airplane, to maintain the same flight altitude. This angle is usually about eight degrees, although it could be a little smaller or a little larger. This angle of attack is illustrated in “The Science of Flight”, by W. N. Hubin, Iowa State University Press, 1992, the disclosure of which is incorporated by reference in its entirety, including at FIG. 5.23. At this angle of attack, the airflow streamline approaching the leading edge of the wing, the stagnation streamline 40, attaches to the wing at a point that is just below the nose 42 of the wing 10, at a slight upward angle θ, as illustrated in FIG. 3. At this point, the air pressure on the wing leading edge is the total pressure of the airflow, the static pressure plus the velocity pressure of the flow. This pressure is a drag force on the wing.

At reduced speeds, the angle of attack increases to maintain level flight, and for landing conditions, a large angle of attack is required to further reduce the speed of the aircraft and keep it flying. If the angle of attack is increased too much, the airplane stalls with a large region of separated air flow 44 on the upper surface 16 of the wing, illustrated in FIG. 4, which results in a very large increase in the drag force, and usually causes the airplane to crash. As the angle of attack is increased, the stagnation point of the approaching airflow moves aft of the nose 42, and the angle of this streamline increases as illustrated in FIG. 4.

The turbulence generators 20 are placed along the leading edge 12 of the wing, at the nose 42 of the wing, proximate at the stagnation streamline point 40 as illustrated in FIG. 3, in an array along the wing as illustrated in FIG. 1, and pointed or angled slightly down from its attachment end to it distal point 28, directly into the air flow approaching the wing, as illustrated in FIG. 5. With this configuration at cruise conditions, the turbulence is not generated, separated air flow 44 is minimized, and the drag of the wing is not increased.

As the angle of the wing is increased, such as during takeoff or landing, a lot of turbulence is generated, which keeps the air flow from separating at high angles of attack as illustrated in FIG. 6, and reduces the airspeed of the airplane. This enables the airplane to land and takeoff in a much shorter distance, with no increase in drag at cruise conditions. These turbulence generators also reduce the stagnation point total pressure and the drag forces at the leading edge of the wing. This reduced drag reduces the aircraft's fuel consumption.

I claim:

1. A wing design for an aircraft, including a plurality of turbulence generating devices distributed along a leading edge of a wing.

2. The wing design of claim 1 wherein the turbulence generators are configured in shape and in orientation to the wing to minimize drag and turbulence during cruising flight, and to increase turbulence during takeoff and landing.

3. The wing design of claim 1 wherein the turbulence generating device is fixed in orientation along the leading edge of the wing.

4. The wing design of claim 1 wherein the turbulence generating devices extend from the leading edge from a position just below a nose of the wing, at a point that defines a stagnation streamline at cruising conditions for the aircraft.

5. The wing design of claim 1 wherein the turbulence generating device is planar, with its plane angled downward relative to a center chord line of a wing profile, and into an airflow stream at cruise condition that approaches the leading edge of the wing with minimal or negligible angle of attack and minimal turbulence generated.

6. The wing design of claim 1 wherein the shape of the turbulence generating device is angular, including triangular, with a corner of the triangular shape extended.
